(19) United States
(12) Patent Application Publication
(10) Pub. No.: US 2018/0264592 A1
(43) Pub. Date: Sep. 20, 2018

(54) METHOD AND DEVICE FOR MODIFYING OBJECT TO BE PROCESSED BY USING ULTRASHORT PULSE LASER

(71) Applicant: LASERNICS, Daejeon (KR)

(72) Inventors: Yunseok KIM, Daejeon (KR); Jooho YOU, Daejeon (KR)

(73) Assignee: LASERNICS, Daejeon (KR)

(21) Appl. No.: 15/760,902

(22) PCT Filed: Jul. 5, 2016
(86) PCT No.: PCT/KR2016/007257

§ 371 Date: Mar. 16, 2018

(30) Foreign Application Priority Data
Sep. 21, 2015 (KR) 10-2015-0132956

(51) Int. Cl. B23K 26/0622; B23K 26/03; B23K 26/08; B23K 26/38

(52) U.S. Cl. CPC B23K 26/0622; B23K 26/38; B23K 26/08; B23K 26/03

(57) ABSTRACT

The present invention relates to a processing device for modifying a surface or an interior of an object to be processed by using an ultrashort pulse laser, the device including: a stage for loading an object to be processed; a laser beam radiating device including a laser source generating an ultrashort pulse laser beam, and a laser processing optical system for radiating laser beam toward the object to be processed loaded on the stage; a laser beam controller capable of setting a laser process condition and three-dimensional spatial coordinates of the object to be processed; and a scanning electron microscope through which the surface of the object to be processed is observed, and a method of modifying, by using the processing device, an object to be processed by cutting a part thereof or processing a surface thereof by using an ultrashort pulse laser.

### TECHNICAL FIELD

The present invention relates to a method and device for modifying an object to be processed by cutting a part thereof or processing a surface thereof by using an ultrashort pulse laser beam.

### BACKGROUND ART

A laser beam may be used as a method of cutting brittle substrates made of glass, silicon, or ceramic, etc. or modifying surface or internal area of object to be processed.

The method of modifying the object to be processed by using an ultrafast pulse laser may be followed by chemical changes, decomposition or evaporation of the object to be processed, and may be effectively used for processing that requires high precision such as imprinting microscopic size of micro pattering.

Meanwhile, ultrafast pulse lasers with pulse width shorter than a picosecond are in the spotlight in industrial fields as well as research fields. An ultrafast pulse laser has a pulse width between several femtoseconds and several picoseconds and may be implemented by using various amplifying media. For example, an ultrafast pulse laser may be built as a bulk-type laser of the central wavelength of 780 nm using Ti:Sapphire for the amplifying medium or as a fiber-based laser by using an Er- or Yb-doped optical fiber with a central wavelength of 1550 nm or 1040 nm. A fiber-based ultrafast laser may have the pulse width of around 100 fs, with advantages of robustness against the environmental change, a small size, and easy maintenance over bulk-type lasers. The high average output over several watts and the high repetition rate over several MHz of such a laser may be implemented easily thanks to the excellent thermal characteristics of the optical fiber itself.

As a conventional method of modifying an object to be processed by using the ultrashort pulse laser, Korean Patent Publication No. 10-2013-0094893 A (Aug. 27, 2013) discloses a method of non-thermally repairing an organic light emitting element using ultrashort pulse laser, and Korean Patent Publication No. 10-2015-0085177 A (Jul. 23, 2015) discloses a method of cutting a brittle substrate using a laser pulse beam.

However, according to the above-mentioned conventional methods, it is difficult to immediately check the changed shape and structure of the directly or indirectly affected area in situ including fragments and debris caused by the laser beam irradiation. In order to check the laser-affected area, an additional analysis device is required.

In addition, a femtosecond laser has more parameters that determine processing performance compared with common industrial nanosecond lasers. To have maximized efficiency for the laser processing, it is required to find an optimal set of parameters by changing different values for each parameter. Such parameters include pulse width, wavelength, pulse energy, a repetition rate, an irradiation time of a laser beam in association with types of an object to be processed, and environmental variables. Since this procedure may include several to dozens of repetitions of radiating laser beam on the object to be processed, checking the result and updating new set of parameters for next trial, it is nearly impossible to run the optimization in situ. To make matters worse, even though an optimal set of parameters are found, a minute change in the environment or the physical properties of object to be processed will affect the conditions and re-evaluating the optimal set may be required. This is another problem which is necessary to be solved for actual industrial applications.

### DISCLOSURE

### Technical Problem

Accordingly, the present invention has been made keeping in mind the above-mentioned problems occurring in the prior art, and an objective of the present invention is to provide a method of modifying an object to be processed by using an ultrashort pulse laser beam, the method being capable of enabling quick and easy investigation of the processing result and rapidly applying a new set of laser parameters of an ultrashort pulse laser beam to be more suitable for the object to be processed judged by analyzing the changed shape and structure of the directly or indirectly affected area in situ including fragments and debris caused by the laser beam irradiation.

In addition, the present invention relates to a processing device for modifying a surface or interior of the object to be processed by using the ultrashort pulse laser, and another objective of the present invention is to provide a processing device for modifying a surface or interior of the object to be processed with capability of easily and quickly checking a process state and rapidly applying a new set of parameters of an ultrashort pulse laser beam to be suitable for the object to be processed according to a modified area by analyzing in situ a changed shape and structure of a surface or interior of the object to be processed including fragments and debris according to radiation of the ultrashort pulse laser beam.

### Technical Solution

In order to accomplish the above-mentioned objective, the present invention provides a method of modifying object to be processed using an ultrashort pulse laser beam, wherein the method modifies the object to be processed by cutting at least a part thereof or processing a surface thereof by using the ultrashort pulse laser beam, the method including: step a) of setting an initial laser process condition and three-dimensional spatial coordinates of the object to be processed for generating a proper ultrashort pulse laser beam for the object to be processed; step b) of modifying, by a laser beam radiating device, the surface or interior of the object to be processed by radiating the ultrashort pulse laser beam toward at least a part of the object to be processed according to the set laser process condition; as step of checking a modified area by observing the object to be processed modified area by the irradiation of the pulse laser beam, step c) of checking, by using a scanning electron microscope, the modified area by observing the object to be processed modified according to radiation of the pulse laser beam by referencing the three-dimensional spatial coordinates of the object to be processed set in step a), and radiating, by an electron beam source emitting an electron beam within the scanning electron microscope, an electron beam toward the object to be processed; and step d) of correcting the laser process condition of the ultrashort pulse laser beam to be suitable for the object to be processed according to the modified area, and of modifying the surface or interior of the object to be processed by radiating an ultrashort pulse laser beam from the laser beam radiating device toward a part of the object to be processed according to the corrected laser process condition.

In one embodiment, the ultrashort pulse laser beam may be generated by any one laser selected from a picosecond (10⁻¹² s) laser, a femtosecond (10⁻¹⁵ s) laser, and an attosecond (10⁻¹⁸ s) laser.

In one embodiment, the object to be processed to which the pulse laser beam is radiated in step d) may be the object to be processed to which the laser beam according to step b) is radiated or a new object to be processed which is the same kind.

In one embodiment, the laser process condition of step a) may be any one of selected from a pulse width, a wavelength, a pulse energy, a repetition rate, and a radiation time.

In one embodiment, the laser beam of the ultrashort pulse laser may be used for removing at least a part of a wiring formed within a semiconductor element or an organic lighting emitting element.

In one embodiment, the steps c) and d) may be repeated at least one time.

In one embodiment, the steps c) and d) may be performed while the object to be processed is fixed, and the scanning electron microscope and the laser beam radiating device respectively move, or the steps c) and d) may be performed while the electron microscope and the laser beam radiating device are respectively fixed, and the object to be processed moves.

In addition, the present invention provides a device for modifying a surface or interior of an object to be processed by using an ultrashort pulse laser, the device including: a stage for loading an object to be processed; a laser beam radiating device including a laser source generating an ultrashort pulse laser beam, and a laser processing optical system for radiating a laser beam generated by the laser source toward the object to be processed loaded on the stage; a laser beam controller capable of setting a laser process condition for generating a proper ultrashort pulse laser beam for the object to be processed and three-dimensional spatial coordinates of the object to be processed; and a scanning electron microscope through which the modified area of the object to be processed caused by the irradiated pulse laser beam is observed, wherein the scanning electron microscope includes: an electron beam source emitting an electron beam; and an aperture being a path through which an electron beam emitted from the electron beam source is radiated towards the object to be processed, wherein the aperture within the scanning electron microscope has a structure including a barrier or an opening structure not including a barrier, and the modified area of the object to be processed according to the radiated laser beam is checked by radiating an electron beam toward the object to be processed by passing the aperture with reference to the three-dimensional spatial coordinates of the object to be processed set by the laser beam controller

In one embodiment, the stage including the object to be processed may be fixed, and the scanning electron microscope and the laser beam radiating device may respectively move, or the scanning electron microscope and the laser beam radiating device may be respectively fixed, and the stage including the object to be processed may move.

In one embodiment, the ultrashort pulse laser may output a pulse width between 100 fs˜500 ps, and the ultrashort pulse laser may have a repetition rate between 1 Hz˜500 MHz.

In one embodiment, the aperture within the scanning electron microscope may have a structure through which the electron beam passes, and the electron beam source emitting the electron beam may be separated from the object to be processed by the barrier, and the barrier may be formed to have a thickness equal to or less than 1000 nm.

In one embodiment, the scanning electron microscope may include: the electron beam source emitting the electron beam; a focusing lens group including an objective lens, and focusing the electron beam to the object to be processed; a vacuum chamber provided with the electron beam source and the focusing lens group therein, and including the aperture that becomes a path through which the electron beam emitted from the electron beam source passes; and at least one deflector controlling and changing a radiation direction of the electron beam.

In one embodiment, the ultrashort pulse laser may be an ultrashort pulse laser based on optical fiber.

### Advantageous Effects

When an object to be processed is modified by using a laser beam radiating device according to a conventional method, in order to determine a process condition, since the laser beam radiating device and a scanning electron microscope (SEM) device are placed spatially far apart, there is limit in terms of time and effort for observing the result. In addition, when a surface state is analyzed after the object to be processed is processed by a laser beam, since the devices are positioned at separate places, it is difficult to rapidly find an optimal set of process parameters by utilizing a scanning electron microscope. Meanwhile, in a method and device for modifying an object to be processed by using an ultrashort pulse laser beam according to an embodiment of the present invention, a laser beam radiating device and a scanning electron microscope including a barrier through which an electron beam passes are combined and used in the same place, thus the changed shape and structure of the directly or indirectly affected area are accurately checked in situ including fragments and debris caused by the laser beam irradiation. Accordingly, a process condition of the ultrashort pulse laser beam can be rapidly changed to be suitable for the object to be processed according to a modified area thereof.

Particularly, in conventional methods, after analyzing the modified area of the object to be processed caused by the radiation of laser beam, when a repetition of process at a certain position is required for the irradiation of the laser beam, it is difficult to rapidly locate the same position, thus analysis and processing at the same position is very difficult. However, in the present invention, three-dimensional spatial coordinates of the object to be processed are set, and observation is performed by referencing the same coordinate for the scanning electron microscope. Thus, when a repetition of a process is performed at the exact same position of the object to be processed, a process condition of a laser beam can be easily optimized.

Accordingly, according to the process device and the method of the present invention, an optimal radiation condition of an ultrashort pulse laser beam for removing a part of a wiring formed within a semiconductor element or an organic light emitting element, or for processing or cutting a brittle substrate can be easily and rapidly determined. Particularly when using a femtosecond laser, compared with common industrial nanosecond lasers, it is difficult to optimize a processes condition of a laser beam in association by types of an object to be processed and by environments. Herein, by analyzing, in situ, the state of the object to be processed modified by the irradiation of the laser beam, the optimized process condition can be easily and rapidly set.

### DESCRIPTION OF DRAWINGS

FIG. 1 is a view showing a processing device for modifying a surface or internal area of an object to be processed according to an embodiment of the present invention.

FIG. 2 is a view showing the processing device for modifying a surface or internal area of an object to be processed according to an embodiment of the present invention in which a modified area of the object to be processed is checked, by using a scanning electron microscope, by moving a stage after radiating a laser beam toward the object to be processed.

FIG. 3 is a view showing a scanning electron microscope of the processing device according to an embodiment of the present invention.

FIG. 4 is a view for illustrating calculating three-dimensional spatial coordinates in a laser processing optical system of the processing device and in a scanning electron microscope according to an embodiment of the present invention.

FIG. 5 is a view showing a flowchart of a method of modifying an object to be processed by using the processing device according to an embodiment of the present invention.

### DESCRIPTIONS OF REFERENCE NUMERALS

1: laser source,
2: reflection mirror
3: laser processing optical system,
4: beam splitter
5: objective lens,
6: object to be processed (specimen)
7: positionally moved object to be processed (specimen),
8: scanning electron microscope
9: supporter having absolute coordinates
11: optical illumination unit
12: optical imaging system,
13: camera
14: absolute coordinate system
20: electron beam source,
22: medium focusing lens
24: objective lens within scanning electron microscope
30: vacuum chamber
37: barrier within aperture,
41, 42: deflector
50: specimen stage,
55: specimen (object to be processed)
60: optical axis,
70: electron beam radiation range

### MODE FOR INVENTION

Hereinafter, a preferred example of the present invention will be described with reference to the attached drawings so that the present invention can be easily carried out by those having the ordinary skill in the technical field to which the present invention belongs. In the drawings of the invention, sizes and dimensions of structures are illustrated by enlarging or reducing as compared with the actual sizes and dimensions to clarify the invention, the known configurations are not illustrated to exhibit characteristic configurations, and the invention is not limited to the drawings. In describing phenomenon of the preferred embodiments of the invention in detail, when it is determined that detailed description of the related known functions or configurations may obfuscate the gist of the invention, the detailed description is omitted.

In the present invention, an object to be processed is an object to which a laser beam is radiated, and means an object that is processed according to intention of a user by having a part of a surface or an interior thereof cut or modified by the laser beam. For example, the object to be processed may correspond to brittle materials such as glass, silicon, sapphire, a SiC substrate, a GaN substrate, a transparent ceramic substrate, etc., an LCD element, an OLED element, a semiconductor element, or polymer materials, but it is not limited thereto.

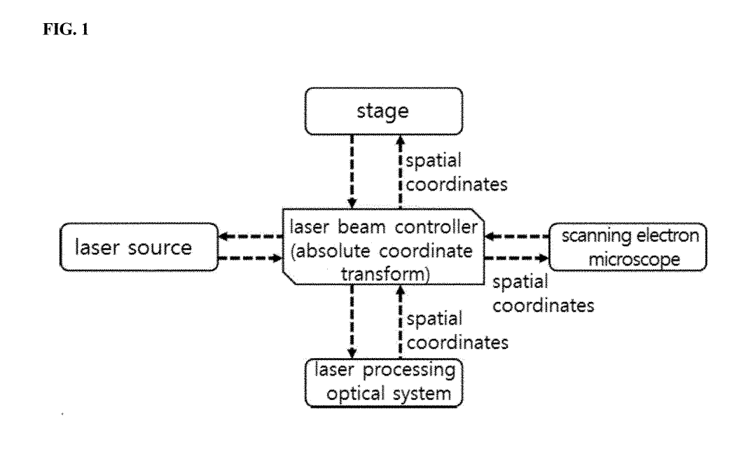

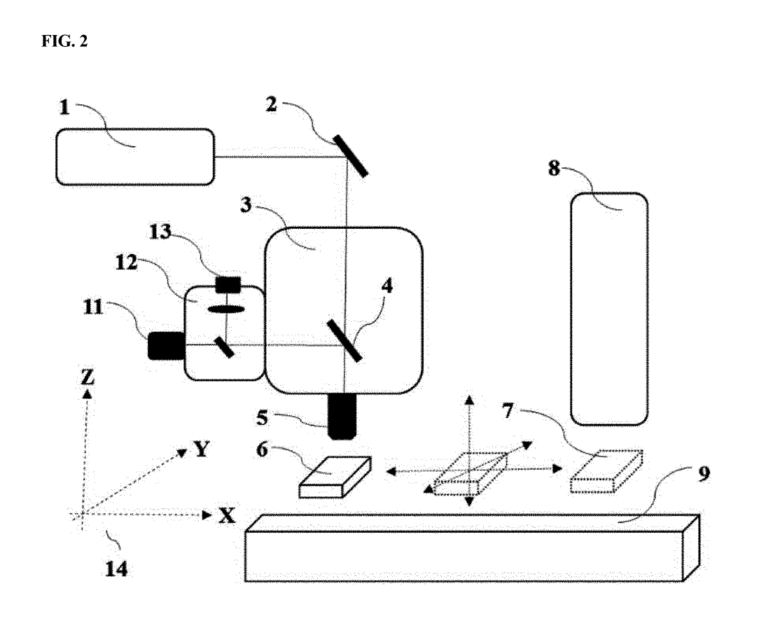

FIG. 1 is a view conceptually showing a processing device for modifying a surface or interior of an object to be processed according to an embodiment of the present invention. In FIG. 1, in the processing device used in the present invention, absolute coordinate of the object to be processed is referenced and shared by a laser source, a laser processing optical system, and a scanning electron microscope from a laser beam controller. In addition, FIG. 2 is a view showing respective elements of the processing device for modifying a surface or interior of an object to be processed according to an embodiment of the present invention in which a modified area of the object to be processed is checked, by using a scanning electron microscope, by moving a stage after radiating a laser beam toward the object to be processed.

Describing in more detail, the processing device of the present invention includes a laser beam radiating device including: a laser source generating an ultrashort pulse laser beam; a laser processing optical system for radiating a laser beam generated from the laser source toward the object to be processed loaded on a stage.

In the present invention, the ultrashort pulse laser beam radiated from the laser beam radiating device may be generated by selecting any one of a picosecond (10⁻¹² s) laser, a femtosecond (10⁻¹⁵ s) laser, and an attosecond (10⁻¹⁸ s) laser.

Herein, the laser source includes a laser resonator generating a pulse laser beam having a pulse width between 100 fs˜500 ps at a final output part thereof. In addition, the laser resonator may be configured by sequentially combining configuration elements such as a laser stretcher stretching the pulse, a pulse amplifier amplifying the stretched pulse, a pulse compressor compressing the amplified pulse, a pulse controller controlling a characteristic of the compressed pulse, etc.

For this, for example, a pulse train with a high repetition rate and a narrow pulse width up to hundreds of femtoseconds may be generated by a method of stretching and amplifying a pulse using an amplification system of a chirped pulse amplification (CPA) type, and then compressing the amplified pulse.

A desired feature may be added to the generated pulse by the pulse controller. For example, the pulse train may pass through only a desired time band, a spatial shape of the pulse wave front may be changed by using a combination of a lens and a mirror, a polarization of the pulse may be controlled by using various kinds of wave plates, and an intensity of the laser may be controlled using a combination of a filter, a polarization beam splitter, a wave plate, etc.

When an ultrashort laser system is used, a preferred average output of the laser beam may have a value between 0.1 W and 1 kW. In addition, the laser may be implemented to have a repetition rate to be implemented in a range of 1 Hz˜500 MHz using a laser resonator based on an optical fiber.

In general, a pulse train having a pulse width under several ten picoseconds and a repetition rate over several ten MHz may be generated by a mode-locking laser resonator, and the mode-locking laser resonator may be classified into a bulk (solid) type and an optical fiber type. The bulk (solid) type resonator includes a mirror, a lens and an amplifying crystal while most of the amplification media and the optical path are replaced with the optical fiber in case of the fiber type resonator. The bulk (solid) type laser may be represented by the Ti-Sapphire femtosecond laser. Due to lack of light source with a high power and good pulse characteristics and scalability of the laser, and difficulty in direct diode laser pumping, the efficiency of the laser is low and maintenance thereof is also difficult due to system complexity.

In contrast, the fiber type laser resonator has advantages over adaptability to industry since the fiber type laser is insensitive to environmental changes such as temperature change and vibration, and the fiber type laser does not require an addition arrangement in case of long-term usage so that stable of long-term usage thereof is possible.

In the present embodiment, an ultrashort pulse laser based on an optical fiber has been manufactured to implement a pulse of a high repetition rate so that a stable pulse having a pulse width of 100 fs˜500 ps may be obtained.

A femtosecond laser based on an optical fiber is less sensitive to vibration when installed in an apparatus than a femtosecond laser based a photonic crystal so downsizing thereof is possible.

Meanwhile, the pulse repetition rate is determined typically by a repetition rate of the laser resonator, and the typical resonator has the repetition rate of about 30 to 250 MHz. For a lower repetition rate, the repetition rate may be decreased to about several MHz by increasing a length of the optical fiber and compensating for the nonlinearity and dispersion phenomena in the optical fiber. The low repetition rate under several Hz may be implemented by applying pulse picker to a post portion of the resonator.

When a high average output is required due to a difference of a kind and thickness of the object to be processed (specimen), and internal stress distribution, etc., chirped pulse amplification may be used to obtain a high output value with the same pulse width. The chirped pulse amplification system includes a pulse stretcher, an amplifier and a compressor. While passing the pulse stretcher, frequency components forming the pulse are expanded along a time axis by a dispersion difference between the frequencies, and thus a peak output may be lowered to a scale equal to or greater than 10³ to prevent optical damage or pulse degradation that may be caused by the high peak output. The pulse is amplified through the amplifier to have a desired output, and the amplified pulse is compressed and returns to the original pulse width by the compressor.

In addition, an output wavelength of the pulse laser may have a range between 300 nm and 3000 nm.

The laser pulse generated in the laser resonator may be controlled by the pulse stretcher, the amplifier and the compressor to have desired properties of the final laser beam being equal to 0.1 W and or less than 1 kW, and 10 ps.

In addition, the pulse laser beam of the laser source may have a peak power density equal to or higher than 10¹¹ W/cm².

In addition, the laser beam radiating device of the present invention may include the laser processing optical system for a radiating pulse laser beam generated in the laser source towards the object to be processed. The laser processing optical system may include a number of mirrors and focusing lenses. The laser processing optical system may transfer a pulse having characteristics desired by the user to the object to be processed that is loaded on the stage through the mirrors and the lenses. The laser beam may be focused into an area having a diameter under tens μm by the focusing lens having ×5 magnification to ×100 magnification. Accordingly, the object to be processed may be processed by finally forming desired peak power density.

In addition, the present invention may include the stage for loading the object to be processed to which the pulse laser beam is radiated. The stage may move the object to be processed in an x direction, in a y direction, and in a z direction which are perpendicular to each other. In addition, the present invention may process the object to be processed by moving the laser beam in the x direction, and the y direction and the z direction which are perpendicular to each other rather than moving the object to be processed in three axes.

In addition, the present invention may include a laser beam controller for setting a laser process condition for generating an ultrashort pulse laser beam that is suitable for the object to be processed, and the setting of the three-dimensional spatial coordinates of the object to be processed. By using the laser beam controller, the laser system including the laser source, the laser processing optical system, and the stage may be controlled. A laser process condition such as pulse width, wavelength, pulse energy, repetition rate, irradiation time, etc. of the laser, and three-dimensional spatial coordinates of the object to be processed may be set by using the laser beam controller. The scanning electron microscope may reference the above-mentioned settings. In addition, the laser beam controller may be monitored by a computer, in other words, whether or not the laser system is normally operating may be monitored.

For example, in order to set a focal point of the laser beam, the laser beam controller may set three-dimensional spatial coordinates of the object to be processed and display the same on a monitor.

For this, the laser processing optical system additionally includes an optical lens, a camera 13, and an optical imaging system 12 such as image storage device. An optical image of the object to be processed to which the laser beam will be processed, and the object to be processed to which the laser beam has been processed may be obtained by the optical imaging system. In the laser beam controller, a spatial coordinate is assigned to the obtained image of the object to be processed with respect to the common absolute reference coordinate of the overall system, and the coordinate of the object to be processed may then be referenced by the laser beam radiating device and the scanning electron microscope.

In addition, the laser processing optical system of the present invention may further include an optical illumination unit 11 including a light source so that the optical image may be more efficiently obtained.

In addition, the laser beam controller of the present invention may monitor a movement and a speed of the laser beam radiated toward the object to be processed, or a movement and a speed of the stage in situ, and may also control the same.

In addition, the laser beam controller of the present invention may be configured in a plurality of controllers such as a first controller and a second controller. Accordingly, the first controller may control the laser source, the laser processing optical system, and the stage, and the second controller may control the remaining parts except the selected parts described above.

As described above, FIG. 2 is a view showing the processing device for modifying a surface or interior of an object to be processed according to an embodiment of the present invention in which a modified area of the object to be processed is checked, by using a scanning electron microscope, by moving a stage after radiating a laser beam toward the object to be processed. A laser beam generated in the laser source 1 is radiated toward the object to be processed by passing the laser processing optical system 3 including a reflection mirror 2, a beam splitter 4, and an objective lens 5, thus the object to be processed (6) is cut or modified.

Herein, the optical illumination unit 11 including the light source radiates light to the object to be processed so that the optical imaging system 12 including the camera 13 may obtain more effectively an image of the object to be processed.

Meanwhile, the scanning electron microscope of the present invention includes an electron beam source emitting an electron beam, and an aperture being a path through which an electron beam emitted to the electron beam source is radiated toward the object to be processed. The aperture of the scanning electron microscope may have a structure including a barrier or an opening structure not including a barrier.

Herein, the aperture is a path through which an electron beam emitted from the electron beam source is radiated toward a specimen by passing the objective lens, and the electron beam source emitting an electron beam is separated from the object to be processed by the aperture. The electron beam passes the aperture and is radiated toward the object to be processed by referencing the three-dimensional spatial coordinates of the object to be processed which is set by the laser beam controller so that a modified area of the object to be processed according to radiation of the laser beam may be checked.

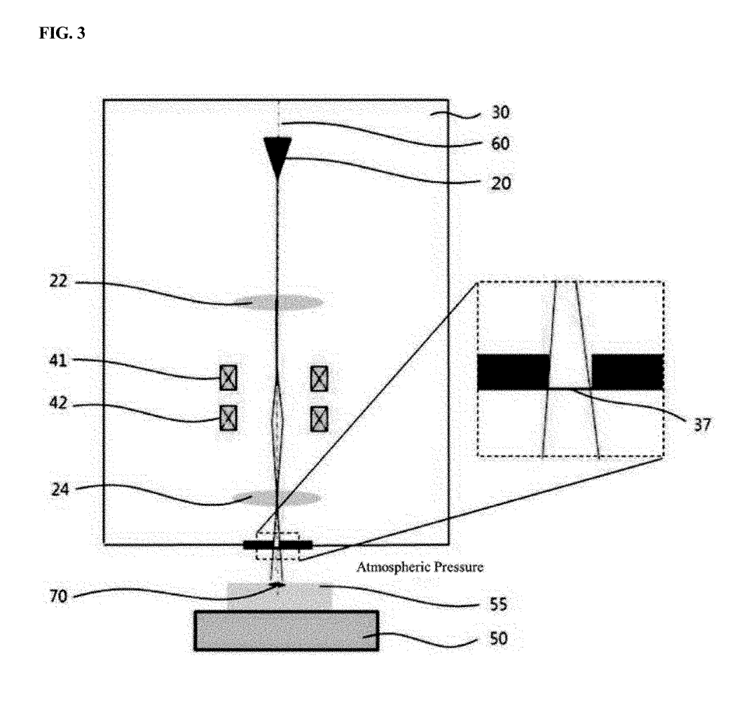

The scanning electron microscope included in the processing device of the present invention is shown in FIG. 3. According to FIG. 3, the scanning electron microscope is provided within a vacuum chamber, an electron beam source 20 emitting an electron beam and the focusing lens group including a medium focusing lens 22 are provided in a side of the electron beam source within the vacuum chamber, and an objective lens 24 that is a final focusing lens and which focuses an electron beam by being provided in a side of the object to be processed (specimen) is included. The processing device may further include: a vacuum chamber 30 including an aperture 37 being a path through which an electron beam emitted from the electron beam source is radiated toward the object to be processed (specimen) by passing the objective lens, and which has a structure including a barrier or has an opening structure not including a barrier; at least two deflectors 41 and 42 provided between the medium focusing lens 22 and the objective lens 24 to control and change a radiation direction of the electron beam; and a stage 50 supporting and moving a specimen 55 positioned at outside of the vacuum chamber.

Herein, the scanning electron microscope includes an aperture through which an electron beam passes. When the aperture has a structure including a barrier, the electron beam source emitting the electron beam is separated from the object to be processed (specimen) by the barrier, and the electron beam passes the barrier and is radiated toward the object to be processed, thus, a range of the electron beam which is radiated toward the specimen may be determined according to a size of the aperture.

Meanwhile, when the aperture has a structure not including a barrier, the electron beam source emitting an electron beam is not completely separated from the object to be processed (specimen) by the aperture, but the scanning electron microscope may be configured to include an internal area enclosed by the vacuum chamber, and an area including the object to be processed (specimen).

Generally, the area including the object to be processed (specimen) may correspond to an interior of a specimen chamber at which the specimen is positioned, and the specimen chamber may be an independent closed area corresponding to a depressurized area by a low vacuum pump or may be an opening area under a pressure identical to a pressure of the air as atmospheric environment.

The scanning electron microscope according to the present invention may include the area including the object to be processed (specimen) to have a pressure relatively higher than a pressure of the internal area of the vacuum chamber.

For example, in the present invention, a pressure difference between the internal area of the vacuum chamber and the area including the object to be processed (specimen) may differ by a degree of 100 times or more. Preferably, it may differ by an amount of 1000 times or more.

Meanwhile, in the present invention, the aperture may be a boarder part dividing the internal area of the vacuum chamber and the area including the object to be processed (specimen). In other words, when the aperture has a structure not including a barrier, the aperture connects the internal area of the vacuum chamber and the area including the object to be processed (specimen), and a cross-sectional surface thereof may be an opening portion having a circular, polygonal, or arbitrary form. In addition, when the aperture has a structure including a barrier, an opening portion thereof may have a form sealed by a thin barrier.

Accordingly, the vacuum chamber may be opened at a narrow area thereof by the aperture, or an internal area thereof is maintained with a high pressure as the vacuum chamber is sealed by the aperture. Thus, an electron beam emitted from the electron beam source within the vacuum chamber may not be scattered and is radiated toward the specimen.

For example, in the present invention, when the interior of the specimen chamber including the object to be processed (specimen) is in a pressure range of 10⁻³ mbar or greater, preferably, a low pressure having a range of 10⁻² mbar or greater, the aperture is formed to have an opening portion so that the aperture is opened, and thus atmosphere of the area including the object to be processed (specimen) may freely in-flow to the internal area of the vacuum chamber.

When the aperture has an opening structure that does not includes a barrier, a pressure of the internal area of the vacuum chamber and a pressure in the area including the object to be processed (specimen) may be different according to a point at which the pressure is measured, as a base position when measuring pressure of the respective areas, for the internal area of the vacuum chamber, a pressure nearby the electron beam source may be measured, and for the area including the object to be processed (specimen), a pressure nearby the specimen on the stage may be measured.

Meanwhile, when a pressure of the area including the specimen is as an atmospheric environment and the aperture is formed with an opening portion, pressure controlling of the area within the vacuum chamber including the electron beam source may not be easily performed. In addition, an emitted electron beam may be scattered or interfered with by air particles present within atmosphere. Thus, it is preferable for the aperture to have an opening form sealed by a thin barrier.

Meanwhile, the scanning electron microscope of FIG. 3 may additionally include a secondary electron detector, and the scanning electron microscope focuses an electron beam emitted from the electron beam within the vacuum chamber to a plurality of focusing lens groups so that the electron beam is radiated on the specimen, or adjusts a beam trajectory by using one or a plurality of deflectors, and moves a radiation position of the electron beam so that the electron beam is radiated on the specimen. A shape of the specimen is observed by using the scanning electron microscope. Herein, since the electron beam may be scattered by colliding with air particles, the internal space within the vacuum chamber including the electron beam source, the focusing lens group, and a beam radiation area between the aperture is maintained in a high vacuum environment by using a vacuum pump.

Herein, in order to maintain the vacuum chamber including the electron beam source, and the focusing lens group to be in a high vacuum state, typically, a vacuum pump may be provided to maintain a pressure of 10⁻⁴ mbar or less, preferably, 10⁻⁵ mbar or less.

Herein, an electron beam emitted from the electron beam source is focused by the focusing lens group based on an optical axis 60 shown in a dotted line in FIG. 3.

Meanwhile, the focusing lens group has a lens aberration, and when the lens aberration becomes large, a spot size of an electron beam becomes large, thus an observation resolution and process accuracy may be degraded.

In addition, when the trajectory of the electron beam deviates from the center of the objective lens, the lens aberration may rapidly increase, and the spot size of the electron beam may become large. For prevention thereof, generally, a deflector may be provided above the objective lens.

In FIG. 3, in order to reduce the lens aberration when radiating an electron beam on the specimen, deflectors are configured in upper-low layers between the objective lens and the medium focusing lens so that the trajectory of the electron beam is controlled to pass the center of the lens.

Meanwhile, the scanning electron microscope is an environmental scanning electron microscope, and a pressure within the specimen chamber of the scanning electron microscope including object to be processed (specimen) satisfies a low vacuum state condition of maintaining equal to or greater than 1×10⁻² mbar. When the specimen does not require a high-pressure state, the aperture may not be formed with the barrier shown in FIG. 3, and simply may be formed to have be opened in an opening form within the vacuum chamber. According to a diameter or a superficial size of the aperture, and a capacity of each vacuum chamber, a pressure difference between the area of the specimen and the internal area of the vacuum chamber including the electron beam source may be adjusted.

For this, an additional vacuum pump is provided, so that the pressure difference with a high vacuum state area of the vacuum chamber including the electron beam source and the focusing lens group may be maintained.

However, in order to observe a living specimen or to check a surface or interior of an object to be processed after modifying and processing by using an ultrashort pulse laser, rather than using the vacuum chamber as the area within the specimen chamber including the object to be processed (specimen), the specimen is placed under atmospheric pressure. For example, the specimen is observed by using an air scanning electron microscope (Air-SEM).

Herein, the aperture includes a barrier having a predetermined thickness as shown in FIG. 3 rather than being formed with an opening portion. For example, the barrier may be made by etching materials such as silicon nitride (SiN), by using thin film materials such as grapheme, or by using a combined layer thereof. Herein the barrier may have a thickness of 1 to 3000 nm. Preferably, the barrier may be formed to have a thickness of 10 to 2000 nm or less, for example, the thickness may have a range of 20 to 500 nm.

Herein, the aperture may have a size with a diameter of 3000 um or less. Preferably, the diameter may be 2000 um or less. More preferably, the diameter may be 1000 um or less.

Meanwhile, a maximum forming area of the electron beam formed on the specimen may be determined by the size of the aperture and a distance between the aperture and the objective lens. In other words, when the size of the aperture is large, or the distance between the aperture and the objective lens is short, the specimen is in a fixed state rather than moving by using the deflector, and a radiation range that is an area in which an electron beam probe is formed may be widely obtained.

In general, when the scanning electron microscope shown in FIG. 3 is used, a pressure nearby the specimen maintains an atmospheric pressure state. In addition, in order to maintain the vacuum chamber including the electron beam source in a high vacuum state of 1×10⁻⁴ mbar or less, the diameter of the aperture has to be very small (<1 mm) and a thin film having a predetermined thickness or less (<hundreds nm) has to be provided.

In addition, the electron beam source used in the present invention has a form capable of generating an electron beam, and as a thermo-electron emitting source, a tungsten having a high melting point and relatively easily emitting electrons, tantalum, iridium, a filament of iridium-tungsten alloy, and a filament on which yttrium, barium, cesium and oxides are coated so that electrons are emitted at a low temperature may be used.

Meanwhile, the focusing lens group focuses an electron beam by suing an electric field or a magnetic field, and includes at least one medium focusing lens 22 provided in a side of the electron beam source 20, and, as a final focusing lens provided in a side of the specimen, includes an objective lens 24 forming a electron beam spot that is focused on the specimen.

The medium focusing lens 22 within the focusing lens group, and the focusing lens group 20 including the objective lens may decelerate or accelerate an electron beam emitted from the electron beam source, or change the beam direction by using electrodes included therein. The electrodes may be in a coil form wrapped in various forms.

Herein, in order to reduce a lens aberration, the electron beam may be controlled to pass the center of the objective lens. In other words, when radiating, the electron beam deflected by the deflector is controlled to pass the center of the objective lens that is the final focusing lens.

In order to implement the same, the deflector may be provided between the medium focusing lens and the objective lens so that the beam direction of the electron beam may be controlled by the deflector.

Meanwhile, the scanning electron microscope may include a vacuum chamber including an aperture being a path through which an electron beam emitted from the electron beam source is radiated toward the specimen by passing an objective lens.

In other words, as described above, the scanning electron microscope may be divided into a high vacuum area of an interior of an vacuum chamber which is enclosed by the vacuum chamber, and an area including the object to be processed (specimen). For example, the internal are of the vacuum chamber may be a high vacuum area having a range of 10⁻⁴ mbar or less. Preferably, it may be a high vacuum area having a range of 10⁻⁵ mbar of less, and for this, a vacuum system including a high vacuum pump may be used for the interior of the vacuum chamber.

For example, the vacuum chamber forms a vacuum space therein in which high vacuum is maintained by using the vacuum pump. Herein, the vacuum pump may be provided by selecting at least one of dry pump, a diffusion pump, a turbo molecular pump, an ion pump, a cryo pump, a rotary pump, and a dry pump of a scroll or diaphragm.

In addition, the area including the object to be processed (specimen) is an area including a specimen. In general, the area may be dependent according to a pressure condition in which the laser processing device of the present invention is used, and typically, the area may be an opening area under a pressure identical to the air.

Meanwhile, the processing device of the present invention may share a stage on which an object to be processed (specimen) is loaded with the scanning electron microscope. The object to be processed (specimen) may be loaded on the stage and processed by the laser beam, and the stage may be shared by being moved to a lower part of an aperture that is below the objective lens of the scanning electron microscope. Alternatively, the stage may be fixed, the object to be processed may be loaded thereon and processed by a laser beam, and the laser beam radiating device and the scanning electron microscope may respectively move.

Herein, the stage supports the specimen below the aperture within the scanning electron microscope by 0.1 to 100 mm. Preferably, the stage supports the specimen in below by 1 to 30 mm, and may be configured to move to x and y directions which are parallel to the ground, and a z direction perpendicular to the ground.

In addition, the deflector within the scanning electron microscope may include at least one coil device generating a magnetic field used for deflecting changed particles.

Typically, the deflector may be provided between the medium focusing lens 22 and the objective lens 24, and as shown in FIG. 3, a plurality of deflectors may be provided between the medium focusing lens 22 and the objective lens 24 in an upper layer 41 and a lower layer 42 so that a trajectory of an electron beam may be set to pass the center of the objective lens.

Herein, according to a size of the aperture, a maximum angle of charged particle beam radiated on the specimen may be limited based on an optical axis. In other words, the electron beam radiated on the specimen may be radiated toward the specimen by being limited within a spatial range 70 having an angle smaller than the maximum angle so that the electron beam passes the inner part of the opening portion rather than passing a part corresponding to an outer-most part of the aperture. When the electron beam is radiated toward the specimen by having an angle wider than the above-mentioned case, the electron beam may not pass the aperture.

In addition, the scanning electron microscope may include at least one connector so that the interior of the vacuum chamber is accessed from outside. The connector is a connecting part for electrically connecting the vacuum chamber and the outside environment, and may be easily used for: (i) providing power and a control signal to the electron beam source and the focusing lens group within the vacuum chamber, (ii) providing a control signal and power to the deflector within the vacuum chamber, and (iii) providing power for a detector capable of providing information whether or not the electron beam source, the focusing lens group, and the deflector of (i) and (ii) malfunction, and a control thereof.

In addition, the scanning electron microscope of the present invention may be provided with a gas injector through which additional gas may be injected, the gas including water vapor, He, nitrogen, and argon for additionally detecting a specimen or enhancing contrast. The above-mentioned gas mixture may be provided nearby the specimen, but it is not limited thereto.

In addition, the scanning electron microscope may additionally include an electron detector having a suitable geometrical form, and dividing various signals emitted from a surface of the specimen into, for example, a low energy secondary electron signal, a high energy back-scattered electron signal, a small angle reflection electron signal, and a large angle reflection electron signal.

The detector is connected to a displaying device such as a display device for showing a shape of the surface of the specimen, and finally displaying the shape in image information.

In addition, the scanning electron microscope adjusts a vacuum degree of the vacuum chamber and emission strength of an electron beam within the electron beam source, and may additionally include a controller therein for controlling the focusing lens group and the deflector.

Accordingly, the controller of the scanning electron microscope may reference three-dimensional spatial coordinates of the object to be processed set from the laser beam controller of the present invention, and radiates an electron beam for obtaining a surface image of the object to be processed which includes an area to be observed among the surface of the object to be processed.

Meanwhile, the controller of the scanning electron microscope may be integrated with the laser beam controller of the present invention, thus the processing device of the present invention may be operated by using one controller.

In the present invention, by the one integrated controller, the laser beam radiating device, the scanning electron microscope, and the stage may be respectively controlled. In the present invention, the method of observing a surface of the object to be processed will be apparent to those of ordinary skill in the art from the description above.

Hereinafter, a method of referencing three-dimensional spatial coordinates of an object to be processed which is set by the laser beam controller, and referencing positional information of the object to be processed for radiating an electron beam on a suitable position by passing the barrier of the scanning electron microscope will be described in detail.

An object to be processed may be loaded on the stage of the laser processing device according to the present invention, then, the object to be processed is cut or modified since an initial laser beam is radiated towards the object to be processed. In order to check the same, the object to be processed (specimen, 6) may be moved to a position 7 by the stage, and moved to a side of the scanning electron microscope 8. Then, an electron beam is radiated by the scanning electron microscope, and an electron microscopy image of the object to be processed may be obtained.

Herein, absolute coordinates of a process position which is generated by the laser beam controller is referenced by the scanning electron microscope, thus the process position is accurately moved to the center of an image forming position of the scanning electron microscope.

For this, in order to be set the scanning electron microscope and the laser processing optical system to one absolute coordinate system, the scanning electron microscope and the processing optical system may be supported and fixed by a supporter 9 having a three-dimensional absolute coordinate system as a structure, and the stage on which the object to be processed is loaded may move with the object to be processed thereon on the supporter 9.

For example, based on an origin of a three-dimensional absolute coordinate system of the supporter, unique three-dimensional position information may be respectively assigned to the scanning electron microscope and the laser processing optical system. By referencing the same, a process specimen may move between the scanning electron microscope and the laser processing optical system by using the stage, and respective positions may be referenced.

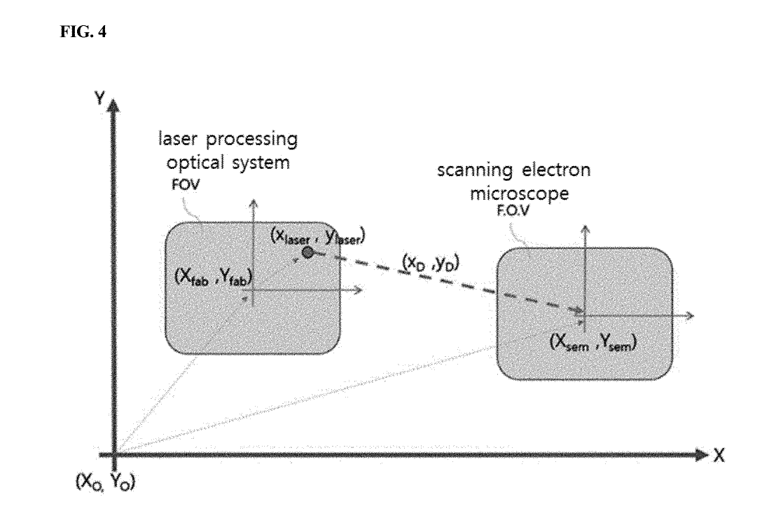

In order to describe the same more detail, FIG. 4 may be referenced.

FIG. 4 is a view for illustrating calculating three-dimensional spatial coordinates in the laser processing optical system of the processing device and in the scanning electron microscope according to an embodiment of the present invention, and FIG. 4 shows a method of setting three-dimensional spatial coordinates of an object to be processed of the present invention.

FIG. 4 shows a method of setting three-dimensional spatial coordinates of an object to be processed in which the scanning electron microscope and the laser processing optical system are respectively supported by the supporter 9 having a three-dimensional absolute coordinate system so that respective positional coordinates of the laser processing optical system and the scanning electron microscope are shared as absolute coordinates.

In one embodiment, in FIG. 4, respective symbols may be defined as below.

(Xo, Yo): origin of absolute coordinates within the supporter 9

(Xfab, Yfab): origin of the laser processing optical system (position in the absolute coordinate system)

(xlaser, ylaser): process positional coordinates based on the origin of the laser processing optical system

(Xsem, Ysem): origin of the scanning electron microscope (position in the absolute coordinate system)

(xD, yD): relative movement distance for moving the process position to the origin of the scanning electron microscope

(si): scale factor applied when transforming image coordinates of the laser processing optical system to the absolute coordinates

Herein, when the original position of the scanning electron microscope in the absolute coordinate system is (Xsem, Ysem), the origin of the absolute coordinate system of the supporter 9 is (Xo, Yo), the origin of the laser processing optical system in the absolute coordinate system is (Xfab, Yfab), and the process positional coordinates based on the origin of the laser processing optical system is (xlaser, ylaser), the relative distance (xD, yD) for moving the process position to the origin of the scanning electron microscope may be represented as the formula below.

xD=Xsem−(Xfab+xlaser*si)

yD=Ysem−(Yfab+ylaser*si)

Herein, the si corresponds to the scale factor applied when transforming the image coordinates of the laser processing optical system to the absolute coordinates.

In addition, the present invention provides a method of modifying an object to be processed by using an ultrashort pulse laser beam as a method of modifying an object to be processed by cutting a part thereof or processing a surface thereof by using an ultrashort pulse laser beam, the method includes: step a) of setting an initial laser process condition for generating a suitable ultrashort pulse laser beam for the object to be processed, and three-dimensional spatial coordinates of the object to be processed; step b) of modifying a surface or an interior of the object to be processed by radiating an ultrashort pulse laser beam according to the preset process condition toward a part of the object to be processed; as a step of checking, by the scanning electron microscope, a modified area of the object to be processed by observing the object to be processed modified according to radiation of the pulse laser beam, step c) of referencing the three-dimensional spatial coordinates of the object to be processed which is set in step a), of radiating, by an electron beam source emitting an electron beam within the scanning electron microscope, an electron beam toward the object to be processed, and thus checking the modified area by observing the object to be processed modified according to radiation of the laser beam; and step d) of correcting a process condition of the ultrashort pulse laser beam to be suitable for the object to be processed according to the modified area, and of modifying the surface or the interior of the object to be processed by radiating, by a laser beam radiating device, an ultrashort pulse laser beam according to the corrected process condition.

Herein, respective configuration elements of the laser beam radiating device of radiating an ultrashort pulse laser beam and the scanning electron microscope are as described above, the scanning electron microscope may share an absolute coordinate system for a process position of the object to be processed in the laser beam radiating device, and thus an electron microscopy image of the process position may be obtained by referencing the three-dimensional spatial coordinates of the object to be processed, and the modified area may be checked by observing the modified object to be processed.

Meanwhile, in the present invention, for the object to be processed to which the pulse laser beam is radiated the in step d), a laser beam may be radiated again for the object to be processed to which laser beam has been already radiated according to step b). Herein, the laser beam may be radiated toward a part identical to a part to which the laser beam has been already radiated, or may be radiated toward a part of the object to be processed which is different to the part to which the laser beam has been already radiated.

In addition, in the present invention, as the object to be processed to which the pulse laser beam is radiated the in step d), a laser beam may be radiated toward a new object to be processed being similar to the object to be processed according to step b) rather than radiating toward the object to be processed to which a laser beam has been already radiated. Accordingly, a condition optimized for a radiation condition of the laser beam or a process condition of the object to be processed may be determined.

In addition, in the present invention, when performing the method of modifying the object to be processed, the object to be processed may be fixed in steps c) and d), and the scanning electron microscope may be respectively moved, or the scanning electron microscope and the laser beam radiating device may be respectively fixed and the object to be processed may be moved. Preferably, the scanning electron microscope and the laser beam radiating device may be respectively fixed, and the object to be processed may be moved.

In addition, in the method of modifying the object to be processed of the present invention, steps c) and d) may be repeated at least one time.

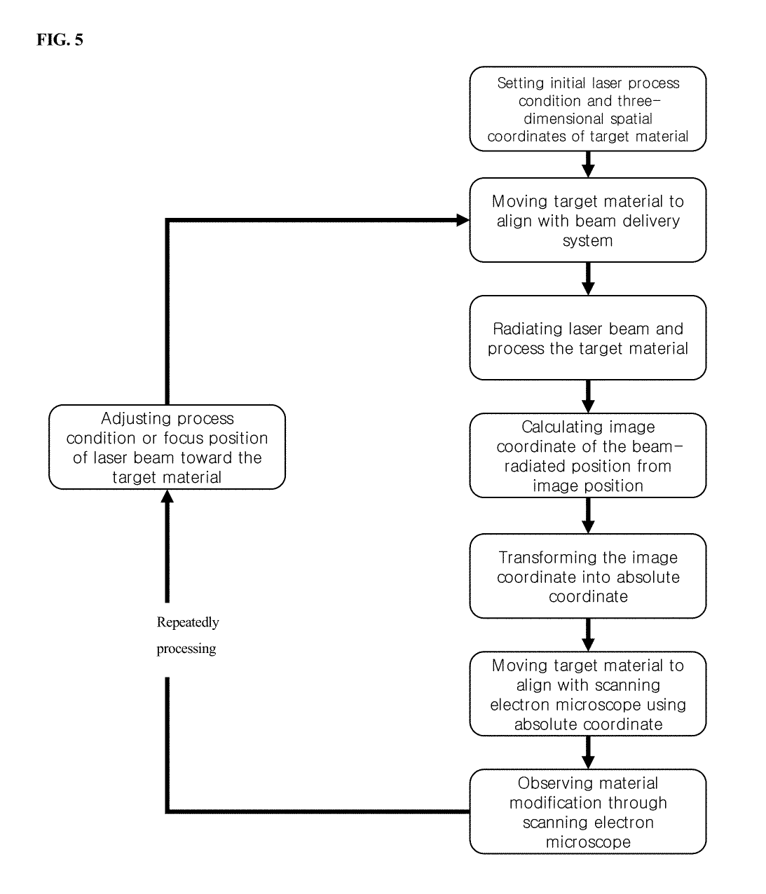

FIG. 5 is a view showing a flowchart in which steps c) and d) of the method of modifying the object to be processed by cutting a part thereof or processing a surface thereof by using an ultrashort pulse laser beam according to the present invention are repeated.

Preferentially, according to step a), an initial laser process condition for generating an ultrashort pulse laser beam suitable for an object to be processed, and three-dimensional spatial coordinates of the object to be processed are set. By step b), the stage including the object to be processed moves to a specific position at which the laser processing optical system is positioned on the supporter having the three-dimensional absolute coordinate system so that the laser beam radiation device may process the object to be processed. Then, by step b), the laser beam radiation device radiates an ultrashort pulse laser beam according to the initial radiation condition of a laser beam in association with the set process condition toward the part of the object to be processed so that the interior of the object to be processed is modified. Then, by using the optical imaging system such as optical microscope included in the laser processing optical system, camera, etc., an image of the process position of the laser processing optical system is obtained. By using the obtained image, respective positions within the image are coordinated by the laser beam controller.

Then, the laser beam controller changes the coordinated positions to a common absolute reference coordinate of the overall system, and references the absolute coordinates of the image of the object to be processed and the absolute coordinates of the scanning electron microscope fixed in the supporter 9. As the stage including the object to be processed moves to a position at which the scanning electron microscope is positioned, and the scanning electron microscope radiates an electron beam. Thus, an electron microscopy image of a process state of the object to be processed may be obtained through secondary electrons emitted from the object to be processed (specimen).

Then, when resetting of the initial process condition for generating the laser beam or the laser beam radiation position of the object to be processed are required, by using information including a resetting condition or radiation position, the stage including the object to be processed (specimen) moves to a predetermined position where the laser processing optical system is positioned, and a laser process may be repeatedly performed at the same or changed position of the object to be processed.

Although some embodiments have been provided to illustrate the present invention in conjunction with the accompanying drawings, it will be apparent to those skilled in the art that the embodiments are given by way of illustration only, and that various modifications and equivalent embodiments can be made without departing from the spirit and scope of the present invention. Further, the description of the drum washing machine as provided herein is only one example of the present invention, and the present invention can be applied to other products. Accordingly, the scope and spirit of the present invention should be limited only by the following claims.

### INDUSTRIAL APPLICABILITY

The present invention relates to a method and device for modifying an object to be processed by cutting at last part thereof or processing a surface thereof by using an ultrashort pulse laser beam, and the present invention is industrially applicable since the present invention is capable of easily checking a process state immediately and rapidly changing a process condition of an ultrashort pulse laser beam to be suitable for the object to be processed according to a modified area by analyzing in real time a changed shape and structure of a surface or interior of the object to be processed including fragments and debris according to radiation of the ultrashort pulse laser beam.

1. A method of modifying an object to be processed using an ultrashort pulse laser beam, wherein the method modifies the object to be processed by cutting a part thereof or processing a surface thereof by using the ultrashort pulse laser beam, the method comprising:
step a) of setting an initial laser process condition and three-dimensional spatial coordinates of the object to be processed for generating a suitable ultrashort pulse laser beam for the object to be processed;
step b) of modifying, by a laser beam radiating device, the surface or interior of the object to be processed by radiating the ultrashort pulse laser beam toward a part of the object to be processed according to the set laser process condition;
step c) of checking, as step of checking a modified area by observing the object to be processed modified by the irradiation of the pulse laser beam, by using a scanning electron microscope, the modified area by observing the object to be processed modified by the irradiation of the pulse laser beam by referencing the three-dimensional spatial coordinates of the object to be processed set in step a), and radiating, by an electron beam source emitting an electron beam within the scanning electron microscope, an electron beam toward the object to be processed; and
step d) of correcting the laser process condition of the ultrashort pulse laser beam to be suitable for the object to be processed according to the modified area, and of modifying the surface or interior of the object to be processed by radiating an ultrashort pulse laser beam from the laser beam radiating device toward a part of the object to be processed according to the corrected laser process condition.

2. The method of claim 1, wherein the ultrashort pulse laser beam is generated by any one laser selected from a picosecond (10⁻¹² s) laser, a femtosecond (10⁻¹⁵ s) laser, and an attosecond (10⁻¹⁸ s) laser.

3. The method of claim 1, wherein the object to be processed to which the pulse laser beam is radiated in step d) is the object to be processed to which the laser beam is radiated according to step b) or a new object to be processed which is the same kind.

4. The method of claim 1, wherein the laser process condition of step a) is any one of selected from a pulse width of the laser, a wavelength, a pulse energy, a repetition rate, and a radiation time.

5. The method of claim 1, wherein the ultrashort pulse laser beam is used for removing a part of a wiring formed within a semiconductor element or an organic emitting lighting element.

6. The method of claim 1, wherein the steps c) and d) are repeated at least one time.

7. The method of claim 1, wherein the steps c) and d) are performed while the object to be processed is fixed, and the scanning electron microscope and the laser beam radiating device respectively move, or the steps c) and d) are performed while the electron microscope and the laser beam radiating device are respectively fixed, and the object to be processed moves.

8. A device for modifying a surface or interior of an object to be processed by using an ultrashort pulse laser, the device comprising:
a stage for loading an object to be processed;
a laser beam radiating device including a laser source generating an ultrashort pulse laser beam, and a laser processing optical system for radiating a laser beam generated by the laser source toward the object to be processed loaded on the stage;
a laser beam controller setting a laser process condition and three-dimensional spatial coordinates of the object to be processed for generating the ultrashort pulse laser beam suitable for the object to be processed; and
a scanning electron microscope through which the surface of the object to be processed according to the radiated pulse laser beam is observed, wherein
the scanning electron microscope includes: an electron beam source emitting an electron beam; and an aperture being a path through which an electron beam emitted from the electron beam source is radiated towards the object to be processed, wherein the aperture within the scanning electron microscope has a structure including a barrier or an opening structure not including a barrier, and
the modified area of the object to be processed according to the radiated laser beam is checked by radiating electron beam toward the object to be processed by passing the aperture with reference to the three-dimensional spatial coordinates of the object to be processed set by the laser beam controller.

9. The device of claim 8, wherein the stage including the object to be processed is fixed, and the scanning electron microscope and the laser beam radiating device respectively move, or the scanning electron microscope and the laser beam radiating device are respectively fixed, and the stage including the object to be processed moves.

10. The device of claim 8, wherein the ultrashort pulse laser outputs a pulse width between 100 fs˜500 ps.

11. The device of claim 8, wherein the ultrashort pulse laser has a repetition rate between 1 Hz˜500 MHz.

12. The device of claim 8, wherein the aperture within the scanning electron microscope has a structure through which the electron beam passes, and the electron beam source emitting the electron beam is separated from the object to be processed by the barrier, and the barrier is formed to have a thickness equal to or less than 1000 nm.

13. The device of claim 8, wherein the scanning electron microscope includes:
the electron beam source emitting an electron beam;
a focusing lens group including an objective lens, and focusing the electron beam to the object to be processed;
a vacuum chamber provided with the electron beam source and the focusing lens group therein, and including the aperture that becomes a path through which the electron beam emitted from the electron beam source passes by passing the objective lens; and
at least one deflector controlling and changing a radiation direction of the electron beam.

14. The device of claim 8, wherein the ultrashort pulse laser is an ultrashort pulse laser based on optical fiber.
